(19) United States
(12) Patent Application Publication
(10) Pub. No.: US 2025/0017132 A1
(43) Pub. Date: Jan. 16, 2025

(54) AUTONOMOUS CULTIVATOR FOR CATTLE MANURE

(71) Applicant: DAIRYCS AUTOMATIC MILKING LTD, Rosh Haayin (IL)

(72) Inventors: Eyal BRAYER, Rosh Haayin (IL); Alon BRAYER, Rosh Haayin (IL)

(21) Appl. No.: 18/769,822

(22) Filed: Jul. 11, 2024

(30) Foreign Application Priority Data
Jul. 13, 2023 (IL) 304475

(51) Int. Cl. A01C 3/08; A01B 49/02

(52) U.S. Cl. CPC A01C 3/08; A01B 17/002; A01B 49/027

(57) ABSTRACT

An autonomous cultivator and method thereof for tilling cattle manure of cattle-shed yard area. The manure comprises a tillage, a wet bulk, and a soaked liquid bottom. The cultivator comprises a propulsion system having a motor interconnected to one or more wheels; a plow comprising a member of a group consisting of a primary tillage implement, a secondary tillage implement and any combination thereof; and a computer system comprising a processor, operably linked and providing instructions to the plow and the propulsion system. The processor comprises a non-transitory program having instructions to operate the propulsion system and the plow until an average water content of the manure in the area is reduced by at least 25% compared to a predetermined threshold.

### CROSS REFERENCE

This application claims the benefit of priority of Israeli Patent Application No. 304475, filed Jul. 13, 2023, the contents of which are all incorporated herein by reference in their entirety.

### FIELD OF THE INVENTION

The present invention is in the field of animal waste, in particular an autonomous cultivator.

### BACKGROUND OF THE INVENTION

In a dairy farm, a dairy cow enjoys its time in a free-range yard, spanning approximately 17 to 26 M². Here, the cow engages in natural behaviors like grazing, ruminating, and defecating. The cow's manure is mainly composed of multi-cellulosic material and water. It is crucial to maintain a dry environment in the cow's living area to ensure its comfort and well-being. Devices to clean cowsheds and the like are disclosed in CN204956222 and, CN213255796. Dry manure not only allows the cow to move around and graze without difficulty but also plays a vital role in preventing the proliferation of detrimental bacteria and potential infections.

Untreated or uncultivated manure comprises a high water (moisture) content, associated with increased levels of anaerobic bacteria and an increased ratio of anaerobic bacteria to aerobic bacteria. An increased level of anaerobic bacteria can be disadvantageous. For example, elevated levels of anaerobic bacteria in cattle manure increase the risk of cattle mastitis, see Du Preez JH. The role of anaerobic bacteria in bovine mastitis: a review. J S Afr Vet Assoc. 1989; 60(3):159-168, herein incorporated by reference in its entity.

Currently, the process of drying the manure involves manual methods. Ventilation by injecting fresh air into the compost is one potential approach. Another method involves cultivating the manure with a cultivator that agitates the manure to facilitate drying. Currently, these cultivation practices are carried out manually, requiring several minutes of human effort each day and necessitating the gathering of the cows into a specific area, away from the ventilation or cultivator. There is an unmet need for a machine and methods that can effectively dry the manure without causing stress to the cow or compromising its quality of life.

An autonomous cultivator useful for effectively and safely tilling cattle manure of cattle-shed yard area is hence still a long-felt need.

### SUMMARY OF THE INVENTION

It is hence an object of the invention to disclose an autonomous cultivator useful for tilling cattle manure (1) of cattle-shed yard area. The manure comprises a tillage (2), a wet bulk (3), and a soaked liquid bottom (4). The cultivator comprises a propulsion system including a motor (5) interconnected to one or more wheels (or any other propulsion means, such as caterpillar, articulated legs, rotatable screws etc. 6). The cultivator also comprises plow (7) comprising a member of a group consisting of a primary tillage implement (8), a secondary tillage implement (9), and any combination thereof. The cultivator further comprises computer system comprising a processor (10), operably linked and providing instructions to the plow (7) and the propulsion system (5). The processor has a non-transitory program having instructions to operate the propulsion system and the plow until an average water content of the manure in the area is reduced by at least 25% compared to a predetermined threshold.

It is another object of the invention to disclose an autonomous cultivator as defined above, wherein the primary tillage implement is selected from the group consisting of: a moldboard, a chisel, a combination of a chisel and cutting blades, a wide-sweep, a disk, a bedder, a moldboard lister, a disk bedder, a subsoiler, a disk harrow, an offset disk, a heavy tandem disk, a powered rotary tiller, and any combination thereof.

It is another object of the invention to disclose an autonomous cultivator as defined in any of the above, wherein the secondary tillage implement is selected from the group consisting of: a harrow, a disk, a spring, a spike, a coil tooth, a tine tooth, a knife, a powered oscillatory spike tooth, a packer, a ridger, a leveler, a rotary ground-driven cultivating member, field conditioner, and any combination thereof.

It is another object of the invention to disclose an autonomous cultivator as defined in any of the above, wherein the instructions are configured to providing a desired cultivator effectivity (variable e) by generating an operating condition for a variable selected from a group consisting of a tilling frequency (variable c), a driving speed (variable g) and any combination thereof.

It is another object of the invention to disclose an autonomous cultivator as defined in any of the above, wherein at least one, two, three or all of the following is held true: the desired cultivator effectivity (variable e) is in a range from 90% to 100%, the 100% effectivity being defined as a 25% reduction in average water content in an average yard area of 20 square meters, after 6 hr of a tilling operation; the driving speed (variable g) is in the range from 0.5 m/s to 2 m/s; and the tilling frequency (variable c) is in the range of 20 RPM to 60 RPM.

It is another object of the invention to disclose an autonomous cultivator as defined in any of the above, wherein the instructions comprise an implementation of an algorithm that uses a multiple dependency model to generate the operating condition, input to the multiple dependency model selected from a group consisting of noise intensity (variable a), noise frequency (variable b), chance of collision (variable d), ratio between aerobic and anaerobic bacteria in the manure (variable f) and any combination thereof.

It is another object of the invention to disclose an autonomous cultivator as defined in any of the above, wherein at least one of the following is held true: the noise intensity (variable a) is in a range from 0 to 85 dB; the noise frequency (variable b) is in a range from 0 to 100 Hz; the chance of collision (variable d) is in a range from 0 to <0.05%; the ratio of aerobic to anaerobic bacteria (variable f) is in a range from 20% to 100%.

It is another object of the invention to disclose an autonomous cultivator as defined in any of the above, wherein the instructions are configured to reduce the average water content after tilling the area twice.

It is another object of the invention to disclose an autonomous cultivator as defined in any of the above, wherein the cultivator further comprises a noise-reducing member, configured to reduce below predetermined thresholds a member of a group consisting of noise intensity (variable a), noise frequency (variable b), and any combination thereof, produced by the tilling operation.

It is another object of the invention to disclose an autonomous cultivator as defined in any of the above, wherein the predetermined threshold for noise intensity is a maximum noise intensity of 85 dB, the predetermined threshold for noise frequency is a maximum noise frequency of 100 Hz.

It is another object of the invention to disclose an autonomous cultivator as defined in any of the above, wherein the noise reducing member is selected from the group consisting of: an insulation material, a vibration-dampening mechanism, a plow with a smooth and controlled turning mechanism, a plow with at least one component with reduced friction, an acoustic shield, an enclosure surrounding the cultivator, and any combination thereof.

It is another object of the invention to disclose an autonomous cultivator as defined in any of the above, wherein it additionally comprising: a chassis or a body (11) interconnected to a member of a group consisting of the propulsion system, the plow, and any combination thereof; and, a collision detection system comprising one or more sensors (12), the collision detection system interconnected to the chassis and operably linked to the computer system, the collision detection system configured to sense an obstacle or object and to respond by taking appropriate action to avoid the collision, the appropriate action comprising a member of a group consisting of changing a direction of movement of the autonomous cultivator, changing a speed of the autonomous cultivator or any combination thereof.

It is another object of the invention to disclose a method for automatically drying cattle manure, the cattle manure comprising a tillage (2), a wet bulk (3), and a soaked liquid bottom (4). The method comprises steps of: providing an autonomous cultivator comprising: providing a propulsion system including a motor (5) interconnected to one or more wheels (as defined above, 6); at least one plow (7) comprising a member of a group consisting of a primary tillage implement (8), a secondary tillage implement (9), and any combination thereof; and, a computer system comprising a processor (10), operably linked and providing instructions to the plow (7) and the propulsion system (5). The method also comprises step of positioning the cultivator in an area comprising the cattle manure; and initiating autonomous operation of the autonomous cultivator, and allowing it to autonomously work for at least 6 hr.

It is another object of the invention to disclose a method as defined above, wherein the method further comprising steps of (d), determining a water content of the cattle manure, and if the water content is reduced by less than 25%, repeating stage (c).

It is another object of the invention to disclose a method as defined in any of the above, wherein the method is enabled by providing autonomous cultivator useful for tilling cattle manure (1) of cattle-shed yard area. the manure comprising a tillage (2), a wet bulk (3), and a soaked liquid bottom (4). The cultivator comprises a propulsion system including a motor (5) interconnected to one or more wheels (or any other propulsion means, such as caterpillar, articulated legs, rotatable screws etc. 6). The cultivator also comprises plow (7) comprising a member of a group consisting of a primary tillage implement (8), a secondary tillage implement (9), and any combination thereof. The cultivator further comprises computer system comprising a processor (10), operably linked and providing instructions to the plow (7) and the propulsion system (5). The processor has a non-transitory program having instructions to operate the propulsion system and the plow until an average water content of the manure in the area is reduced by at least 25% compared to a predetermined threshold.

It is another object of the invention to disclose a method as defined in any of the above, wherein the primary tillage implement is selected from the group consisting of: a moldboard, a chisel, a combination of a chisel and cutting blades, a wide-sweep, a disk, a bedder, a moldboard lister, a disk bedder, a subsoiler, a disk harrow, an offset disk, a heavy tandem disk, a powered rotary tiller, and any combination thereof.

It is another object of the invention to disclose a method as defined in any of the above, wherein the secondary tillage implement is selected from the group consisting of: a harrow, a disk, a spring, a spike, a coil tooth, a tine tooth, a knife, a powered oscillatory spike tooth, a packer, a ridger, a leveler, a rotary ground-driven cultivating member, field conditioner, a rod weeder, and any combination thereof.

It is another object of the invention to disclose a method as defined in any of the above, wherein the instructions are configured to providing a desired cultivator effectivity (variable e) by generating an operating condition for a variable selected from a group consisting of a tilling frequency (variable c), a driving speed (variable g) and any combination thereof.

It is another object of the invention to disclose a method as defined in any of the above, wherein at least one, two, three or all of the following is held true: the desired cultivator effectivity (variable e) is in a range from 90% to 100%, the 100% effectivity being defined as a 25% reduction in average water content in an average yard area of 20 square meters, after 6 hr of a tilling operation; the driving speed (variable g) is in the range from 0.5 m/s to 2 m/s; and the tilling frequency (variable c) is in the range of 20 RPM to 60 RPM.

It is another object of the invention to disclose a method as defined in any of the above, wherein the instructions comprise an implementation of an algorithm that uses a multiple dependency model to generate the operating condition, input to the multiple dependency model selected from a group consisting of noise intensity (variable a), noise frequency (variable b), chance of collision (variable d), ratio between aerobic and anaerobic bacteria in the manure (variable f) and any combination thereof.

It is another object of the invention to disclose a method as defined in any of the above, wherein at least one of the following is held true: the noise intensity (variable a) is in a range from 0 to 85 dB; the noise frequency (variable b) is in a range from 0 to 100 Hz; the chance of collision (variable d) is in a range from 0 to <0.05%; the ratio of aerobic to anaerobic bacteria (variable f) is in a range from 20% to 100%.

It is another object of the invention to disclose a method as defined in any of the above, wherein the instructions are configured to reduce the average water content after tilling the area twice.

It is another object of the invention to disclose a method as defined in any of the above, wherein the cultivator further comprises a noise-reducing member, configured to reduce below predetermined thresholds a member of a group consisting of noise intensity (variable a), noise frequency (variable b), and any combination thereof, produced by the tilling operation.

It is another object of the invention to disclose a method as defined in any of the above, wherein the predetermined threshold for noise intensity is a maximum noise intensity of 85 dB, the predetermined threshold for noise frequency is a maximum noise frequency of 100 Hz.

It is another object of the invention to disclose a method as defined in any of the above, wherein the noise reducing member is selected from the group consisting of: an insulation material, a vibration-dampening mechanism, a plow with a smooth and controlled turning mechanism, a plow with at least one component with reduced friction, an acoustic shield, an enclosure surrounding the cultivator, and any combination thereof.

It is another object of the invention to disclose a method as defined in any of the above, wherein it additionally comprising: a chassis or a body (11) interconnected to a member of a group consisting of the propulsion system, the plow, and any combination thereof; and, a collision detection system comprising one or more sensors (12), the collision detection system interconnected to the chassis and operably linked to the computer system, the collision detection system configured to sense an obstacle or object and to respond by taking appropriate action to avoid the collision, the appropriate action comprising a member of a group consisting of changing a direction of movement of the autonomous cultivator, changing a speed of the autonomous cultivator or any combination thereof.

### BRIEF DESCRIPTION OF THE DRAWINGS

The presently disclosed subject matter may be more clearly understood upon reading in the following detailed description embodiments of non-limiting exemplary embodiments thereof, with reference to the drawings.

Dimensions of components and features shown in the figures are chosen for convenience or clarity of presentation and are not necessarily shown to scale. Wherever possible, the same reference numbers will be used throughout the drawings and the following description to refer to the same and like parts.

FIG. 1 is a schematic, not-to-scale illustration of a depth cross section of manure in a cowshed yard, including a first external dry, dense and hard tillage layer, a second layer composed of wet bulk, and a third layer composed of liquid soaked bottom;

FIG. 2 is a schematic perspective view of an autonomous cultivator according to some embodiments of the invention;

FIG. 3 is an exemplary radar graph demonstrating an exemplary dependency model between noise intensity (variable a), noise frequency (variable b), tilling frequency (variable c), chance of collision (variable d), efficiency (variable e), and, aerobic vs. anaerobic bacteria (variable f) according to some embodiments of the invention; and

FIG. 4A-D are schematic illustrations of the cultivator, of a method of operation of the cultivator and modules thereof, according to some embodiments of the invention.

### Detailed Description of the Preferred Embodiments

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

As used herein the terms “cultivating” and “tilling” are used interchangeably and refer to the operation of manipulating and disrupting the top layer of the soil or the manure. The cultivating operation involves using implements or machinery to break up the compacted soil, creating a loose and friable texture. By breaking up the manure, displacing it, or both, air reaches the deeper layers of the manure, improving oxygen availability for the bottom layers.

The terms “dry”, “ventilate”, “aerate”, and “reduce water content” are herein used interchangeably.

The term “plow” refers in a non-limiting manner to primary tillage, secondary tillage, cultivating tillage and any combination or variation thereof. Primary tillage is more aggressive, deeper, and leaves a rougher soil surface than secondary tillage. Primary tillage implements as are agrotechnical machinery configured to displace and shatter soil to reduce soil strength in the tillage layer. Cultivating tillage implements perform shallow post-plant tillage to aid the crop by loosening the soil and/or by mechanical eradication of undesired vegetation. Combination primary tillage typically comprises implements performing primary tillage functions and utilizing two or more dissimilar tillage components as integral parts of the implement (not as attachments to a first tillage instrument).

Non-limiting examples of primary tillage implements are a moldboard, a chisel, a combination chisel with cutting blades, a wide-sweep, a disk, a bedder, a moldboard lister, a disk bedder, a subsoiler, a disk harrow, an offset disk, a heavy tandem disk, and a powered rotary tiller.

Secondary tillage as defined hereinafter comprises agrotechnical machinery configured to till the soil to a shallower depth than primary tillage implements, provide additional pulverization, mix pesticides and fertilizers into the soil, level and firm the soil, close air pockets, and eradicate weeds. Seedbed preparation is the final secondary tillage operation.

Non-limiting examples of secondary tillage implements are a harrow, a disk, a spring, a spike, a coil, a tine tooth, a knife, a powered oscillatory spike tooth, a packer, a ridger, a leveler, a rotary ground-driven cultivators, a field or field conditioner, and a rod weeder.

Non-limiting examples of cultivating implements are a row crop cultivator, a rotary ground-driven cultivating member, spring tooth cultivating member, shank tooth cultivating member, rotary hoes cultivating member, rotary tillers-strip type cultivating member, and power driven cultivating member.

Non-limiting examples of combinations of components used in primary tillage are a coulter blade, a subsoiler shank, a chisel plow shank; and chisel plow shanks and disc blades. Non-limiting examples of combination secondary tillage are implements that perform secondary tillage functions and utilize two or more dissimilar tillage components as integral parts of the implement (not as attachments). Examples of combinations of components used in secondary tillage are e.g., spike tines cultivating member, spike teeth cultivating member, and disc blades cultivating member; packer rollers cultivating member and spring teeth cultivating member and three-implement hitch cultivating member.

The term “noise-reducing member” refers to any instrument or substance that is configured to reduce noise intensity, noise frequency, or both, produced by a tilling operation. Non-limiting examples of noise-reducing members are an insulation material, a vibration-damping mechanism, a plow with a smooth and controlled turning mechanism, a plow with at least one component with reduced friction, an acoustic shield, an enclosure surrounding the cultivator, or any combination thereof.

The term “weight sensor”, hereinafter refers to a device used to measure the force or weight applied to it by another object. A weight sensor converts the mechanical force exerted on it into an electrical signal that can be measured and interpreted. Non-limiting examples of a weight sensor are a load cell or a weight transducer.

Load cells are commonly used in various applications such as industrial weighing scales, medical equipment, automotive systems, and robotics. They are designed to accurately measure both static and dynamic loads. There are different types of weight sensors, but one common design is based on strain gauge technology. A strain gauge is a device that changes its electrical resistance when subjected to mechanical strain or deformation. Load cells using strain gauges typically consist of a metal structure with one or more strain gauges attached to it. When a force is applied to the load cell, it deforms slightly, causing the strain gauges to change their resistance. This change in resistance is proportional to the applied force, allowing the measurement of weight or force.

The electrical signal produced by the strain gauge is typically very small, so it needs to be amplified and processed to obtain accurate weight measurements. This is usually done using a Wheatstone bridge circuit or specialized signal conditioning electronics.

As used herein, the terms “tilling frequency” or “cultivating frequency” refer to the rotational speed of the tines or blades on the tilling equipment, typically measured in revolutions per minute (RPM). The appropriate tilling frequency can depend on factors such as soil type, moisture content, and the specific purpose of tilling (e.g., seedbed preparation or weed control). Different crops or soil conditions may require different tilling frequencies for optimal results.

The term “multiple dependency model” is a graphical representation used to display and compare multiple variables or dimensions simultaneously. It is particularly useful for visualizing the relationships and dependencies between different factors. The multiple dependency model used by the computer system disclosed herein is used to define axes, analyze dependencies and compare the shapes or patterns formed by the different variables. Non-limiting examples of a multiple dependency model are a radar chart or a spider chart.

As used herein, the term “about” when combined with a value refers to plus or minus 10% of the reference value. For example, a length of about 1,000 nanometers (nm) refers to a length in a range of 1,000 nm±100 nm (900 nm to 1,100 nm).

It is noted that as used herein and in the appended claims, the singular forms “a”, “an”, and “the” include plural referents unless the context clearly dictates otherwise.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination.

In a free-range dairy farm, where cows have ample living space of 17 to 26 square meters per cow, the challenge lies in managing their manure, which consists mainly of multi-cellulosic material and water, along with trace amounts of various chemicals. Traditionally, the yard was maintained manually by periodically removing the manure with shovels, aiming to concentrate it and create a suitable environment for the cows. The drier and less swampy the yard, the better the cows' quality of life, enabling comfortable grazing for 15 to 17 hours a day and unhindered movement for accessing food and water.

A more efficient method of drying cattle manure involves drying through ventilation by injecting fresh air into the deposit, coupled with daily turning and refreshing using cultivator teeth. This approach optimizes the drying process, resulting in improved efficiency. Additionally, it is commonly believed that providing an extra caloric input per day further enhances the composting process and benefits the cows.

To address the challenge of turning and refreshing the yard, often done during milking or by temporarily relocating the cows to one side, the invention discloses an autonomous cultivator and a method of using such.

In some embodiments, the autonomous cultivator comprises a vessel, roughly the size of one or two cows, preferably cylindrical, cuboid or comprising at least a portion of a sphere with a diameter of approximately one and a half meters. The cylinder can have either a horizontal or vertical axis. In some embodiments, the vessel is enclosed within a sheath made of plastic, tin, rubber, or a combination thereof. In some embodiments, it is equipped with one or more wheels at the bottom. The vessel comprises a plow element configured to turn the manure. The plow element tills the waste at specific points or small areas, such as a square meter. In some embodiments, after each tilling operation, the machine advances to a new point, continuing the turning process. By operating continuously for hours or even around the clock, this machine could effectively save space by efficiently refreshing (turning) the manure for improved drying.

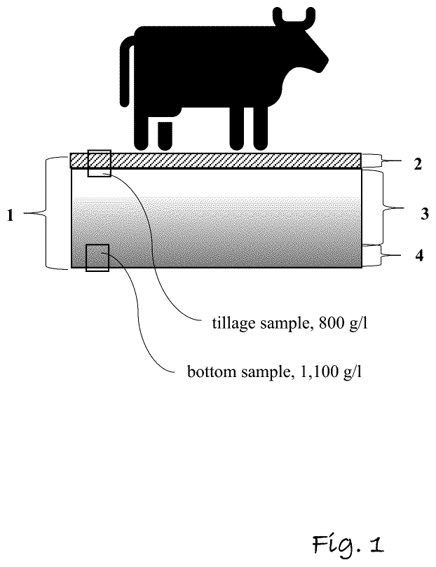

Drying cattle manure is of great importance. As illustrated as cross section 1 in FIG. 1, the cattle manure is composed of three layers: a first external dry, dense and hard tillage layer (2), a second layer composed of wet bulk (3), and a third, innermost layer, composed of liquid soaked bottom (4).

The present invention, in some embodiments, discloses an autonomous cultivator configured to drive autonomously around a yard and ventilate the soil by cultivating it. In some embodiments, the soil comprises cattle manure.

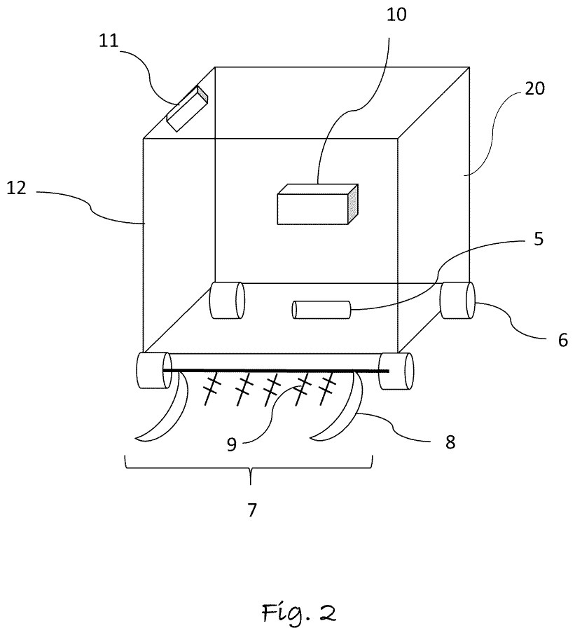

FIG. 2 shows an exemplary embodiment of an autonomous cultivator. The cultivator comprises a propulsion system with a motor (5) interconnected to one or more wheels (6); a plow (7) comprising a primary tillage implement (8); a secondary tillage implement (9), and any combination or variation thereof; and a computer system comprising a processor (10), operably linked to and providing instructions to the plow (7) and the propulsion system (5).

Operation of the autonomous cultivator is consistent with minimal disturbance to the cattle, since no human is required and since the cultivator can be programmed to traverse slowly. In some exemplary configurations, the motor is electric, which can generate very little noise when powering a propulsion system. The operation time or operation duration of the autonomous cultivator can range between 1 hr and 24 hr a day, between 1 hr and 12 hr, or between 1 hr and 6 hr. Each possibility represents a separate embodiment of the invention.

The autonomous cultivator further comprises: a chassis or a body (11) interconnected to the propulsion system, the plow, and any combination thereof; and a collision detection system comprising one or more sensors (12) interconnected to the chassis and operably linked to the computer system, designated to sense an obstacle or object and to respond by taking appropriate action to avoid the collision such as, but not limited to, some combination of changing the direction of movement of the autonomous cultivator or changing the speed of the autonomous cultivator.

Sensor(s) may comprise, for non-limiting example, at least one of a proximity sensor and a bump sensor. A sensor may use IR technology, laser technology, or other such technologies. Changing the cultivator direction can be achieved by a processor (10), the processor receiving information from at least one sensor and determining from the information whether to continue in a given path or to calculate a new path. In the latter case, the processor can affect the rotational motion of the wheel(s) (6), turning the cultivator to a different direction.

The autonomous cultivator can comprise a noise-reducing member configured to reduce noise intensity (variable a), noise frequency (variable b), or both (both variable a and variable b), produced by the tilling operation, thereby reducing the noise (intensity, frequency or both) below at least one predetermined threshold.

The sensitivity of cattle, sheep and pigs to sound, and the levels to which they are exposed, has been extensively investigated. Cattle hear high-frequency sounds much better than humans, with their high-frequency hearing limit being 37 kHz, compared with only 18 kHz for humans. The threshold for discomfort for cattle was noted at 90-100 dB, with physical damage to the car occurring at 110 dB. It is noted that cattle, with an auditory range between 25 Hz and 35 kHz, can detect lower pitched sounds than other farm species, with dairy breeds being even more sensitive to noise than beef breeds (Broucek, Jan. Effects of noise on performance, stress, and behavior of animals: A review. Slovak J. Anim. Sci. 2014; 47:111-123).

The autonomous cultivator is configured to limit the generated noise to a noise intensity below 85 dB, a noise frequency below 100 Hz, or both, in order to allow long hours of operation during times when cattle are present, without disturbing or stressing the cattle.

The processor comprises a non-transitory program having instructions to operate the propulsion system and the plow until the average water content of the manure in the area is reduced by at least 25%, compared to a predetermined threshold.

As shown in FIG. 1, the weight density of the top tillage layer (2) has been examined and was found to be 800 gr/liter. The density of the liquid-soaked bottom layer (4) was found to be 1100 gr/liter, indicating that, in some embodiments, the autonomous cultivator could operate until the density of all manure layers is a homogenous 800 gr/liter. In some embodiments, the autonomous cultivator can be operated over one or more areas in order to determine for a typical or an average operation time needed to achieve the desired weight density of 800 gr/liter of layer 4, after which the processor instructions are modified so as to spend the observed operation time in each area.

In some embodiments, the cultivator can further comprise a weight sensor and a sampling mechanism (as is known in the art), allowing sampling from the liquid-soaked bottom layer and determining its weight density in order to determine the amount of time spent cultivating the area.

The processor comprises instructions configured to control the tilling frequency (variable c) and driving speed (variable g) so as to till each area with a desired effectivity (variable e).

Higher tilling frequencies generally result in faster manure processing and increased effectivity (variable e) by means of more thorough mixing of organic matter, but they may also require more power and can increase noise intensity, noise frequency, and wear and tear on the equipment.

In one example, 100% effectivity was defined as a 25% reduction in average water content in an average yard area of 20 square meters after 6 hr of a tilling operation.

In another example, the driving speed was in the range of 0.5 to 2 meters/second, and the tilling frequency was in the range of 20 to 60 RPM.

In some embodiments, the program comprises instructions implementing an algorithm that uses a multiple dependency model in order to determine the operation time, tilling frequency (variable c), and driving speed (variable g).

This algorithm takes into consideration the correlation between the desired effectivity (variable e), and the variables that increase cattle stress or compromise overall welfare of the cattle, including noise intensity (variable a), noise frequency (variable b), chance of collision (variable d), and the ratio between aerobic and anaerobic bacteria in the manure (variable f).

In some embodiments, the variables have values in the range of 0<noise intensity (variable a) <85 dB; 0<noise frequency (variable b)<100 Hz; 20 RPM <tilling frequency (variable c)<60 RPM; 0<chance of collision (variable d)<0.05%; 90%<efficiency (variable e)<100%; and, 20%<aerobic vs. anaerobic bacteria (variable f)<100%.

It is noted that monitoring or detecting stress in cattle is well described in the art, and requires paying attention to its behavior, body language, and physiological signs. In some embodiments, a stressed cow exhibits at least one sign selected from: (a) agitation and restlessness, (b) reduced rumination time, (c) increased vocalization, more frequent vocalization, vocalization with a higher pitch than usual or both, (d) signs of tension in body language (e.g., a stiff posture, a raised head, a tense facial expression, flared nostrils, or wide eyes), (e) a decrease in feed intake or water consumption compared to normal patterns, (f) aggressive behavior towards other cattle or increased dominance behaviors, (g) reduced milk production, (h) increased respiratory rate, (i) excessive salivation or a frothy mouth, (j) decreased fertility or irregular estrus cycles in a breeding cattle, or (k) any combination thereof.

As used herein, rumination is the process of regurgitation, remastication, salivation, and swallowing of ingesta to reduce the particle size of feedstuffs and enhance fiber digestion, and is known to be associated with cow welfare. Typically, non-stressed cattle spend 25 to 80 min ruminating per kg of roughage consumed and, typically, a mature dairy cow ruminates for 7 to 10 h per day.

Monitoring rumination can be performed by readily-available electronic rumination monitoring systems that use sensors to track a cow's rumination activity and provide data on rumination time, frequency, and patterns.

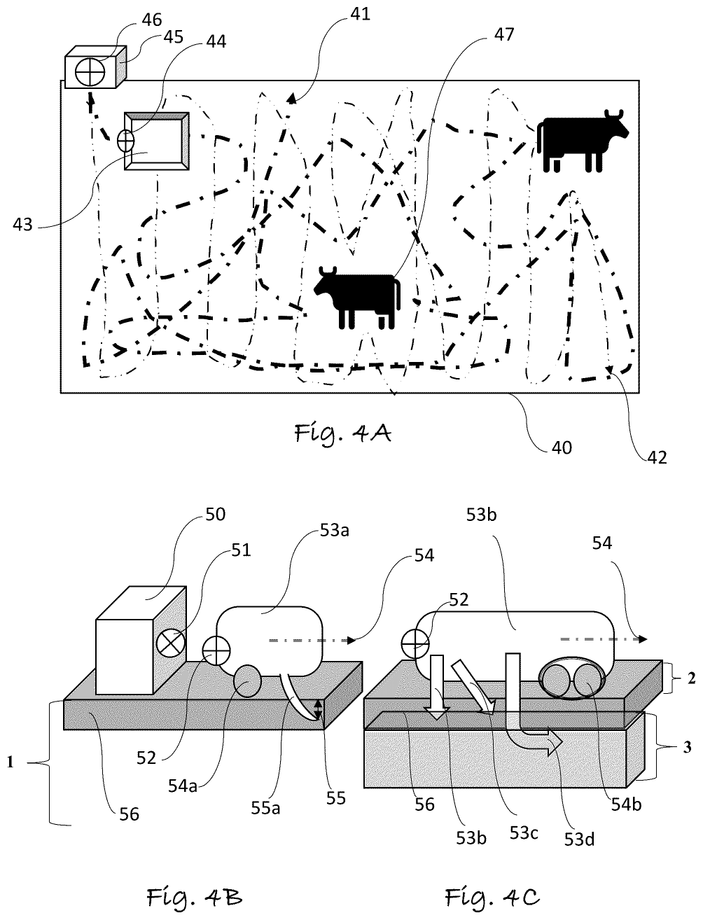

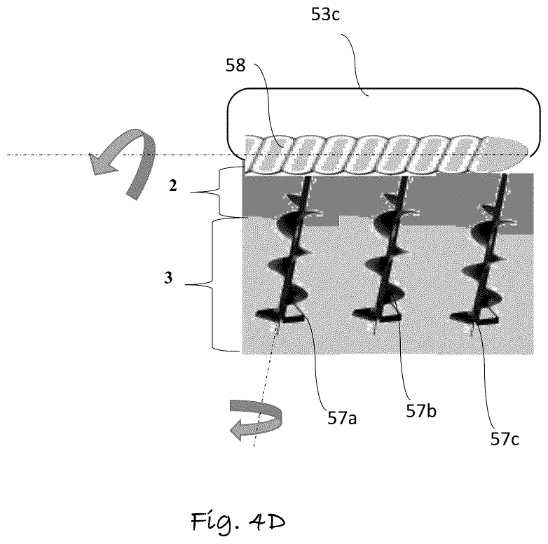

Reference is now made to FIG. 4A-C, each of which schematically illustrates, in a non-limiting manner, top and side (lateral cross section-) views of a yard 40 to be tillaged, according to some embodiments of the invention. An electrically-activated autonomous cultivator 43 can have a movement for tilling cattle manure of a cattle shed yard area that is partially random motion, 41 in a partially predefined pattern, or any combination thereof. The predefined motion can be, e.g., a slalom 42 or a zigzag. The propulsion system advances the cultivator in a continuous manner so that, in a predetermined time period t (defining the tilling frequency), the average water content of the manure in yard 40 is reduced by at least 25% compared to a predetermined threshold. Time period 1 ranges from (i) about 0.5 to about 6 hours in a medium size yard under relatively non-humid conditions (e.g., a relative humidity RH<50%), to (iia) about 6 to about 12 hours in a medium size yard at relatively high humidity (e.g., 50<RH<75%), or (iib) about 12 to about 24 hours in a medium size yard under very humid conditions (e.g., RH>75%). Non-limiting examples of other important factors determining the time period t comprise local wind velocity and direction, farm altitude, land temperature, precipitation, degree of cloud cover, atmospheric stability, cattle density in the yard, yard shape, and animal type and age.

Reference is now made to FIGS. 4A to 4D showing various embodiments of the invention wherein, e.g., the electrically-activated autonomous cultivator 43, 53a is charged by a charger 45, 50, respectively, a static charger or a movable one. In some embodiments, after a predetermined time, when required or any combination thereof, the cultivator autonomously approaches the charger in a predefined configuration so that cultivator's electricity supply inlet 44, 52 faces the charger's electric supply outlet 46, 51 (respectively).

As schematically depicted in FIG. 4B, according to some embodiments of the invention, autonomous cultivator 53a comprises or is otherwise provided in connection with at least one a plow (55a), the plow being a member of a group consisting of a primary tillage implement, a secondary tillage implement, and any combination thereof. Plow 55a is shaped, e.g., as a horn-like curved member configured to penetrate a predetermined thin depth 55 in the cattle manure's top portion (hard crest, 2 in FIG. 1). In the embodiment shown, the propulsion system includes a rear wheel 54a that pushes cultivator 53a.

Reference is made now to FIG. 4C, showing another embodiment of the invention where a coil-like horizontally-propelling mechanism 58 mounted on- or provided in connection with a light weight cultivator. the invention here that the cultivator is light weight and other means are providing the tillage effective, other than cultivator's (relatively high-) self-weight. In some embodiments, a combination of rear and front wheel drive is used. At least one plow is schematically illustrated as one or both of the following: vertical advancing tooth (e.g., a linearly reciprocating and/or vibrating drill 53b) and a tilted or otherwise curved plow (53c); both are configured to tillage the topical surface (section 2) of the deposited manure (section 1). Additionally, or alternatively, plow 53d is configured to penetrate deeper portions of the manure, e.g., section 3. Those configurations allow the cultivation of the manure at the initial stages of the propulsion. Reference is made now to FIG. 4D, showing another embodiment of the invention where the propulsion system (54c) comprising coiled propelling means, comprising one or a few or an array of many auger-like acromechanics (57a-c) of the same shape and size or of different configuration.

### EXAMPLE 1

A method for automatically drying cattle manure is provided useful, when the cattle manure comprises a tillage, a wet bulk, and a soaked liquid bottom. The method comprises steps of providing an autonomous cultivator with a propulsion system including a motor interconnected to one or more wheels; further providing a plow with a member of a group consisting of a primary tillage implement, a secondary tillage implement, and any combination thereof; and also providing a computer system comprising a processor, operably linked and providing instructions to the plow and the propulsion system; positioning the cultivator in an area comprising the cattle manure; initiating autonomous operation of the autonomous cultivator, and allowing it to autonomously work for at least 6 hours, so that e.g., water content of the cattle manure is reduced so that the water content is no more than 75% of the initial water content at the start of tillage.

for such an autonomous cultivator and method of operation, a radar chart establishes the following parameters: Variable a: Noise Intensity (range 0-100 dB)-value: 85; Variable b: Noise Frequency (range 0-1000 Hz)-value: 76; Variable c: Tilling Frequency (range 0-100 RPM)-value: 60; Variable d: Chance of Collision (range 0-100%)-value: 0.05; Variable e: Effeciency (range 0-100%)-value: 90; Variable f: Acrobic vs. Anaerobic Bacteria (range 0-100%)-value: 25.

Normalizing the values based on their respective ranges: Variable a: (85/100)=0.85; Variable b: (76/1000)=0.76; Variable c: (60/100)=0.6; Variable d: (0.05/100)=0.0005; Variable e: (90/100)=0.9; Variable f: (25/100)=0.25.

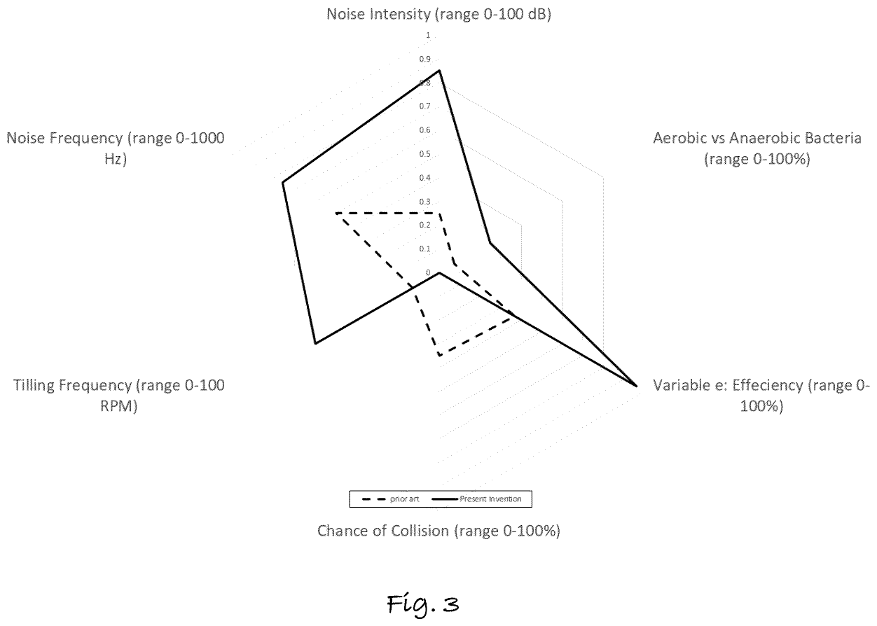

By plotting the normalized values on the radar chart, the inventors obtain the coordinates presented in FIG. 3: A: (0.85, 0); B: (0.76, 60 degrees); C: (0.6, 120 degrees); D: (0.0005, 180 degrees); E: (0.9, 240 degrees); F: (0.25, 300 degrees).

Connecting these data points forms a polygon on the radar chart. Calculation of its area was performed using the Shoelace formula, an algorithm to determine the area of a simple polygon whose vertices are described by their Cartesian coordinates in the plane

$$\\ {{Area}_{}}_{[ autonomus cultivator ]} = 0.5 * \vert ( 0.85 * 60 + 0.76 * 120 + 0.6 * 180 + 0.0005 * 240 + 0.9 * 300 + 0.25 * 0 ) - ( 0 * 0.85 + 60 * 0.76 + 120 * 0.0005 + 180 * 0.9 + 240 * 0.9 + 300 * 0.25 \vert = 238$$

Therefore, the calculated area for the given parameters, namely the normalized overall efficiency of the hereto disclosed and claimed autonomous cultivator is 238.

The aforementioned normalized overall efficiency of the autonomous cultivator is more than 50% better than man-operated agromachining of the prior art (Area [PRIOR ART]=152), see Table 1 below:

TABLE 1
Comparing of normalized overall efficency of the autonomous
cultivator of an embodiment of the invention with
man operated agro-machining of the prior art:

| | Prior | Present |
|---|---|---|
| | Art | Invention |
| Noise Intensity (range 0-100 dB) | 0.25 | 0.85 |
| Noise Frequency (range 0-1000 Hz) | 0.5 | 0.76 |
| Tilling Frequency (range 0-100 RPM) | 0.13 | 0.6 |
| Chance of Collision (range 0-100%) | 0.35 | 0.0005 |
| Efficiency (range 0-100%) | 0.37 | 0.96 |
| Aerobic vs Anaerobic Bacteria (range 0-100%) | 0.075 | 0.25 |
| Normalized overall efficency value | 152 | 238 |

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. An autonomous cultivator useful for tilling cattle manure (1) of a cattle-shed yard area,
said manure comprising a tillage (2), a wet bulk (3), and a soaked liquid bottom (4); and
said cultivator comprising:
a propulsion system including a motor (5) interconnected to one or more wheels (6);
a plow (7) comprising a member of a group consisting of a primary tillage implement (8), a secondary tillage implement (9), and any combination thereof; and,
a computer system comprising a processor (10), operably linked and providing instructions to said plow (7) and said propulsion system (5);
wherein said processor has a non-transitory program having instructions to operate said propulsion system and said plow until an average water content of said manure in said area is reduced by at least 25% compared to a predetermined threshold.

2. The autonomous cultivator of claim 1, wherein said primary tillage implement is selected from the group consisting of: a moldboard, a chisel, a combination of a chisel and cutting blades, a wide-sweep, a disk, a bedder, a moldboard lister, a disk bedder, a subsoiler, a disk harrow, an offset disk, a heavy tandem disk, a powered rotary tiller, and any combination thereof.

3. The autonomous cultivator of claim 1, wherein said secondary tillage implement is selected from the group consisting of: a harrow, a disk, a spring, a spike, a coil tooth, a tine tooth, a knife, a powered oscillatory spike tooth, a packer, a ridger, a leveler, a rotary ground-driven, a field or field conditioner, a rod weeder, and any combination thereof.

4. The autonomous cultivator of claim 1, wherein said instructions are configured to providing a desired cultivator effectivity (variable e) by generating an operating condition for a variable selected from a group consisting of a tilling frequency (variable c), a driving speed (variable g) and any combination thereof.

5. The autonomous cultivator of claim 4, wherein:
said desired cultivator effectivity (variable e) is in a range from 90% to 100%, said 100% effectivity being defined as a 25% reduction in average water content in an average yard area of 20 square meters, after 6 hr of a tilling operation;
said driving speed (variable g) is in the range from 0.5 m/s to 2 m/s; and
said tilling frequency (variable c) is in the range of 20 RPM to 60 RPM.

6. The autonomous cultivator of claim 4, wherein said instructions comprise an implementation of an algorithm that uses a multiple dependency model to generate said operating condition, input to said multiple dependency model selected from a group consisting of noise intensity (variable a), noise frequency (variable b), chance of collision (variable d), ratio between aerobic and anaerobic bacteria in said manure (variable f) and any combination thereof.

7. The autonomous cultivator of claim 6, wherein:
said noise intensity (variable a) is in a range from 0 to 85 dB;
said noise frequency (variable b) is in a range from 0 to 100 Hz;
said chance of collision (variable d) is in a range from 0 to <0.05%;
said ratio of aerobic to anaerobic bacteria (variable f) is in a range from 20% to 100%.

8. The autonomous cultivator of claim 1, wherein said instructions are configured to reduce said average water content after tilling said area twice.

9. The autonomous cultivator of claim 1, further comprising a noise-reducing member, configured to reduce below predetermined thresholds a member of a group consisting of noise intensity (variable a), noise frequency (variable b), and any combination thereof, produced by said tilling operation.

10. The autonomous cultivator of claim 9, wherein said predetermined threshold for noise intensity is a maximum noise intensity of 85 dB, said predetermined threshold for noise frequency is a maximum noise frequency of 100 Hz.

11. The autonomous cultivator of claim 9, wherein said noise reducing member is selected from the group consisting of: an insulation material, a vibration-dampening mechanism, a plow with a smooth and controlled turning mechanism, a plow with at least one component with reduced friction, an acoustic shield, an enclosure surrounding the cultivator, and any combination thereof.

12. The autonomous cultivator claim 1, additionally comprising:
a chassis or a body (11) interconnected to a member of a group consisting of said propulsion system, said plow, and any combination thereof; and,
a collision detection system comprising one or more sensors (12), said collision detection system interconnected to said chassis and operably linked to said computer system, said collision detection system configured to sense an obstacle or object and to respond by taking appropriate action to avoid the collision, said appropriate action comprising a member of a group consisting of changing a direction of movement of said autonomous cultivator, changing a speed of said autonomous cultivator or any combination thereof.

13. A method for automatically drying cattle manure, said cattle manure comprising a tillage (2), a wet bulk (3), and a soaked liquid bottom (4); the method comprising steps of:
(a) providing an autonomous cultivator comprising:
a propulsion system including a motor (5) interconnected to one or more wheels (6);
a plow (7) comprising a member of a group consisting of a primary tillage implement (8), a secondary tillage implement (9), and any combination thereof; and,
a computer system comprising a processor (10), operably linked and providing instructions to said plow (7) and said propulsion system (5);
(b) positioning the cultivator in an area comprising the cattle manure;
(c) initiating autonomous operation of the autonomous cultivator, and allowing it to autonomously work for at least 6 hr.

14. The method of claim 13, further comprising steps of determining a water content of said cattle manure, and if the water content is reduced by less than 25%, repeating stage (c).
